(19) United States
(12) Patent Application Publication
(10) Pub. No.: US 2014/0114663 A1
(43) Pub. Date: Apr. 24, 2014

(54) GUIDED SPEAKER ADAPTIVE SPEECH SYNTHESIS SYSTEM AND METHOD AND COMPUTER PROGRAM PRODUCT

(71) Applicant: Industrial Technology Research Institute, Hsinchu (TW)

(72) Inventors: Cheng-Yuan Lin, Miaoli County (TW); Cheng-Hsien Lin, New Taipei City (TW); Chih-Chung Kuo, Hsinchu County (TW)

(73) Assignee: Industrial Technology Research Institute, Hsinchu (TW)

(21) Appl. No.: 14/012,134

(22) Filed: Aug. 28, 2013

(30) Foreign Application Priority Data
Oct. 19, 2012 (TW) 101138742

(51) Int. Cl. G10L 13/047

(52) U.S. Cl. CPC G10L 13/047
USPC 704/260

(57) ABSTRACT

According to an exemplary embodiment of a guided speaker adaptive speech synthesis system, a speaker adaptive training module generates adaptation information and a speaker-adapted model based on inputted recording text and recording speech. A text to speech engine receives the recording text and the speaker-adapted model and outputs synthesized speech information. A performance assessment module receives the adaptation information and the synthesized speech information to generate assessment information. An adaptation recommendation module selects at least one subsequent recording text from at least one text source as a recommendation of a next adaption process, according to the adaptation information and the assessment information.

### CROSS-REFERENCE TO RELATED APPLICATION

The present application is based on, and claims priority from, Taiwan Application No. 101138742 filed Oct. 19, 2012, the disclosure of which is hereby incorporated by reference herein in its entirety.

### TECHNICAL FIELD

The present disclosure relates generally to a guided speaker adaptive speech synthesis system and method and a computer program product thereof.

### BACKGROUND

To construct a speaker dependent speech synthesis system, it is required to record a large number of speech samples with consistent prosody under a professional recording environment no matter the system is corpus-based or statistics-based one.

For example, recoding sound samples controlled in a consistent speaking style for more than 2.5 hours. The hidden Markov model (HMM)-based speech synthesis system coupled with a speaker adaptation technology may provide a fast and stable solution of a personalized speech synthesis system. The major principle of the technology is to adapt an average voice model constructed in advance to a new voice model according to a small amount of speech data collected from a new speaker. Generally, the amount of the collected speech data could be less than 10 minutes.

As shown in FIG. 1, an exemplary HMM-based speech synthesis system firstly receives a text string, then converts the text string into a full label format string 112 readable by a text-to-speech (TTS) system through text analysis 110, such as sil-P14+P41/A: 4̂0/B: 0+4/C: 1=14/D: 1 @6. Subsequently, the model indices of three kinds of model files can be obtained by traversing three model decision trees based on the full label string. The three model decision trees are a spectrum model decision tree 122, a duration model decision tree 124, and a pitch model decision tree 126, respectively. Each model decision tree may contain about hundreds to thousands HMM models. For example, the aforementioned full label format string sil-P14+P41/A: 4̂0/B: 0+4/C: 1=14/D: 1@6 is converted into phone information and model information as follows:

### Phone is P14.

The spectrum model indices of states 1-5 are 123, 89, 22, 232, and 12.
The pitch model indices of states 1-5 are 33, 64, 82, 321, 19.
Next, the phone information and model information are used to perform the synthesis 130.

There are lots of speech synthesis approaches. Generally, most of speaker adaptation strategies are to collect adaptation data as much as possible. However, there is no any specific design on the contents of adaptation data for different speakers. In some known technologies, some works suggest to adopt a small amount of adaptation data to adapt all speech models and design an adaptation data sharing scheme among all models. Since each speech model represents different speech characteristics, it will possibly blur the original speech characteristics if the data sharing is excessively used and also affect voice quality of synthetic speech further.

Some speaker adaptation strategies distinguish speaker-dependent features and speaker-independent features at first, and then adjust speaker dependent features and integrate speaker independent features to perform speech synthesis. Some speaker adaptation strategies adapt the original pitch and formant by referring to some technology similar to voice conversion. Most of speaker adaptive speech synthesis systems focus on the development of speaker adaptive algorithms, but there is no any further exploration on the design of adaptation data. So far, there is little literature using model coverage information or speech distortion.

Some speech synthesis technologies shown in FIG. 2, combine high-level description messages in a speaker adaptation stage 210, such as context-dependent prosody information, to adapt spectral, fundamental frequency, and duration models of the target speaker. These technologies focus on adding high-level description messages instead of any assessment of prediction about the performance of the generated speaker adapted model. Some speech synthesis techniques, such as shown in FIG. 3, evaluate the performance of synthesized speech according to the perceptual speech quality measurement. In addition, they use the similar criteria to re-estimate the model transformation matrices of the target speaker. However, they do not perform any assessment of prediction about the performance of the generated speaker adapted model.

In above or existing speech synthesis technologies, some technologies analyze user input from the text-level rather than adaptation results. Some propose to use a fixed recording script prepared in advance for speaker adaptation. However, using the identical recording script is not suitable for different target speakers.

For most of speaker adaptation approaches, text-level analysis is simply performed based on the phoneme category of the target language without the consideration of initial voice model. However, it is impossible to see the whole picture of speech models if only phone information is considered to design the recording script. This is because that such recording script can not collect balanced speech data, thus it usually causes adapted models biased.

In view of this, how to design a speaker adaptive speech synthesis technology to assess or predict the generated speech adaptive model, select and recommend adaptation utterances considering the model coverage and speech distortion, is an important issue.

### SUMMARY

The exemplary embodiments of the present disclosure may provide a guided speaker adaptive speech synthesis system and method and a computer program product thereof.

One exemplary embodiment relates to a guided speaker adaptive speech synthesis system. The system may comprise a speaker adaptive training module, a text to speech engine, a performance assessment module, and an adaptation recommendation module. The speaker adaptive training module generates the adaptation information and a speaker-adapted model, according to a recording text and at least one corresponding recording utterance. The text to speech engine receives the recording text and the speaker-adapted model, and outputs a synthesized speech information. The performance assessment module refers to the adaptation information and the synthesized speech information to generate an assessment information. The adaptation recommendation module selects at least one subsequent recording text from at least one text source as a recommendation of a next adaption process, according to the adaptation information and the assessment information.

Another exemplary embodiment relates to a guided speaker adaptive speech synthesis method. The method may comprise: inputting at least one recording text and at least one recording speech, and outputting an adaptation information and a speaker-adapted model; loading the speaker-adapted model and inputting a recording text, and outputting a synthesized speech information; inputting the adaptation information and the synthesized speech information, and estimating an assessment information; and selecting at least one subsequent recording text from at least one text source as a recommendation of a next adaption process, according to the adaptation information and the assessment information.

Yet another exemplary embodiment relates to a computer program product of a guided speaker adaptive speech synthesis. The computer program product may comprise a storage medium having a plurality of readable program codes, and use at least one hardware processor to read the plurality of readable program codes to execute: inputting at least one recording text and at least one recording speech, and outputting an adaptation information and a speaker-adapted model; loading the speaker-adapted model and inputting a recording text, and outputting a synthesized speech information; inputting the adaptation information and the synthesized speech information, and estimating an assessment information; and selecting one or more subsequent recording texts from at least one text source as a recommendation of a next adaption process, according to the adaptation information and the assessment information.

The foregoing and other features of the exemplary embodiments will become better understood from a careful reading of detailed description provided herein below with appropriate reference to the accompanying drawings.

### BRIEF DESCRIPTION OF THE DRAWINGS

FIG. 1 shows a schematic view illustrating an exemplary HMM-based speech synthesis system.

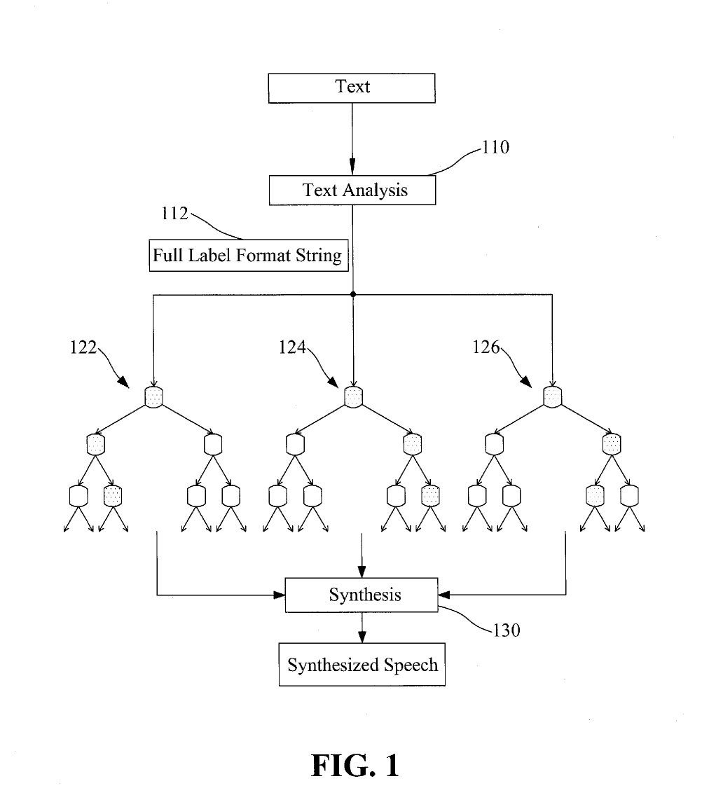

FIG. 2 shows a schematic view illustrating a speaker conversion technique by combining the high-level description messages and the model self-adaption.

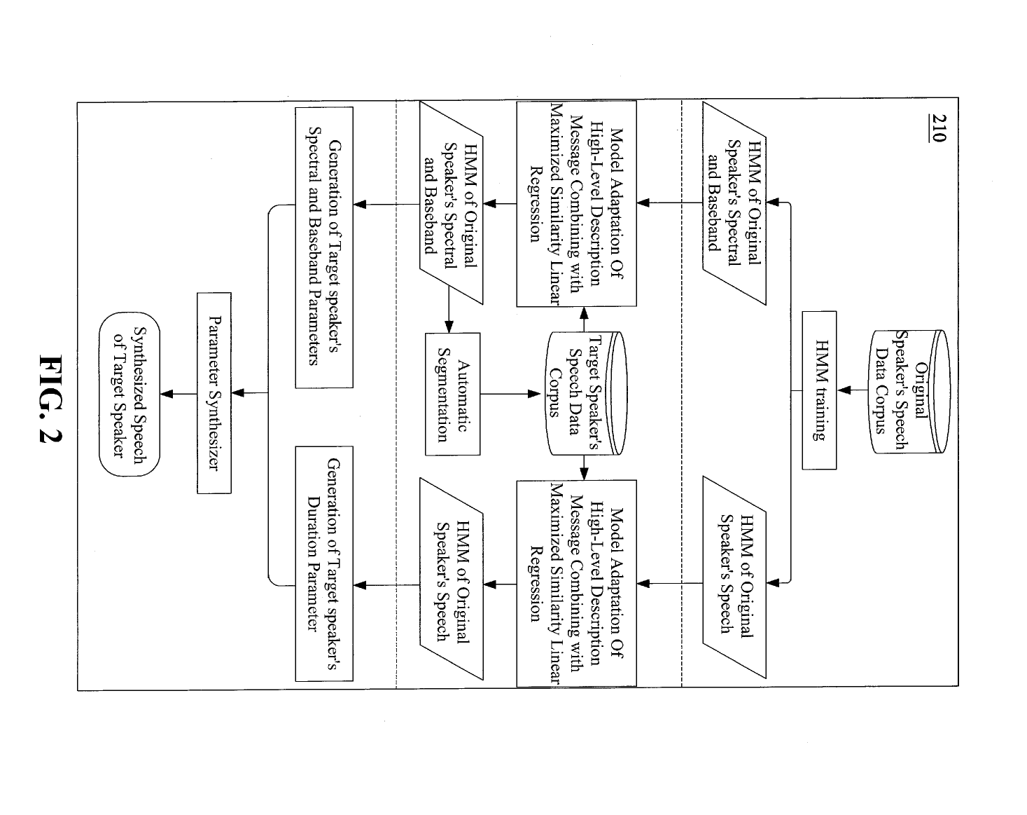

FIG. 3 shows an exemplary schematic view illustrating a model adaptation technology based on a perceptual loss minimization of speech generated parameters.

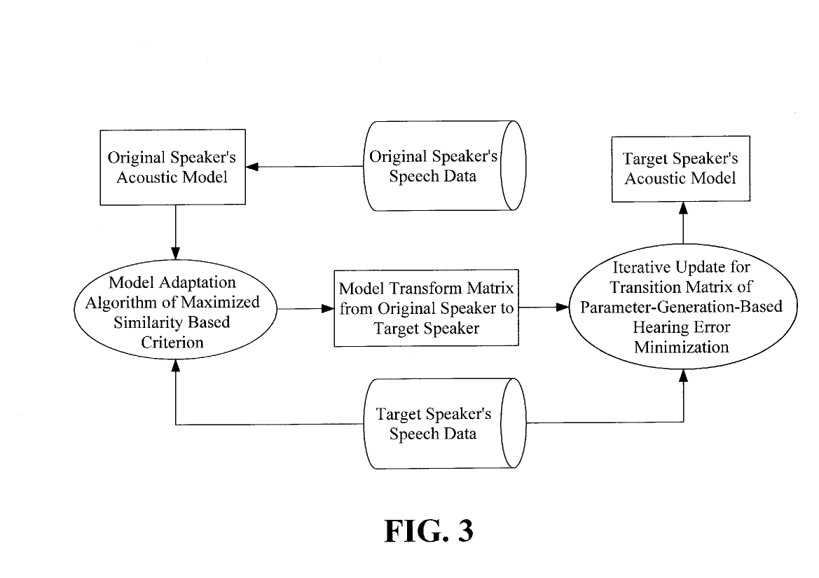

FIG. 4 shows a guided speaker adaptive speech synthesis system, according to an exemplary embodiment.

FIG. 5 shows an example illustrating the speaker adaptive training module collects the corresponding phones and the model information for each of full label information from an input text, according to an exemplary embodiment.

FIG. 6 shows an exemplar for estimating the phone coverage rate and the model coverage rate, according to an exemplary embodiment.

FIG. 7 shows the operation for estimating the spectral distortion by the performance assessment module, according to an exemplary embodiment.

FIG. 8 shows the operation of the adaptation recommendation module, according to an exemplary embodiment.

FIG. 9 shows a guided speaker adaptive speech synthesis method, according to an exemplary embodiment.

FIG. 10 shows a flow chart for a phone-based convergence algorithm, according to an exemplary embodiment.

FIG. 11 shows a flow chart for a model-based convergence algorithm, according to an exemplary embodiment.

FIG. 12 shows an adjustment scheme of weight re-estimation, according to an exemplary embodiment.

FIG. 13 shows a representative view illustrating the spectral distortion of a speech of which the spectral distortion calculation unit is phone, according to an exemplary embodiment.

### DETAILED DESCRIPTION OF THE EXEMPLARY EMBODIMENTS

Below, exemplary embodiments will be described in detail with reference to accompanied drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

The exemplary embodiment of a guided speaker adaptive synthesis technology makes a recommendation for a next adaptation by using such as the inputted recording speeches and the text contents, which guides the user inputting speech data again to perform reinforcing for the deficiencies of a previous adaptation process. Wherein the performance assessment may be divided into a coverage assessment and a spectral distortion assessment. In the exemplary embodiments, the estimation result of the coverage rate and the spectral distortion may be coupled with an algorithm, such as the design of a greedy algorithm, which selects the most suitable adaptation sentence from a text source and returns the assessment results to the user or the client, or to a module to handle the text and speech input. Wherein the coverage rate may be obtained by converting the input text to a string of a readable full label format, and then analyzing the coverage rate corresponding to the phone and the speaker-independent model content. The spectral distortion may be determined by comparing the spectral parameters of both the recording speech and the adapted synthesized speech after time alignment.

Speaker adaptation basically uses the adaptation data to adapt all speech models. The speech models may be multiple HMM spectrum models, multiple HMM duration models and the multiple HMM pitch models, which are referred by a HMM-based framework. In the exemplary embodiments, the adapted speech models in the speaker adaptation process may be, but not limited to the HMM spectrum models, the HMM duration models and the HMM pitch models, which are referred by a HMM-based framework. Takes the aforementioned HMM-based models as an example for illustrating the speaker adaptation and training. Theoretically, if the model numbers mapped to the adaptation data with full label format are widely distributed, that is, the adaptation data can be used to adapt most of models in the original TTS system, the obtained adaptation results should be better. Based on this viewpoint, the exemplary embodiments design a selection method, such as a greedy algorithm, to maximize the model coverage, and the selection method selects at least one subsequent recording text to perform the speaker adaptation efficiently.

The state of the art speaker adaptation technique performs the adaptation training of speech independent (SI) speech synthesis models according to inputted recording speech to generate a speech adaptive (SA) speech synthesis models, and uses a TTS engine to perform directly the speech synthesis according to the SA speech synthesis models. Different from the current technologies, the exemplary embodiments of the speech synthesis system in the disclosure, a performance assessment module and an adaptation recommendation module are added to make a recommendation of different subsequent recording texts according to the current results in the speaker adaptation process, and provide users (clients) with assessment information of current adaptation speech for reference. The performance assessment module may estimate the phone coverage, the model coverage and the spectral distortion for the adaptation speech. The adaptation recommendation module may select at least one subsequent recording text from the text source as a recommendation of the next adaptation, according to the adaptation results. The assessment information of the current adaptation speech is estimated by the performance assessment module. Accordingly, by the way of constant adaptation and providing the text recommendation for performing effective speaker adaptation, the speech synthesis system may provide the good sound quality and similarity.

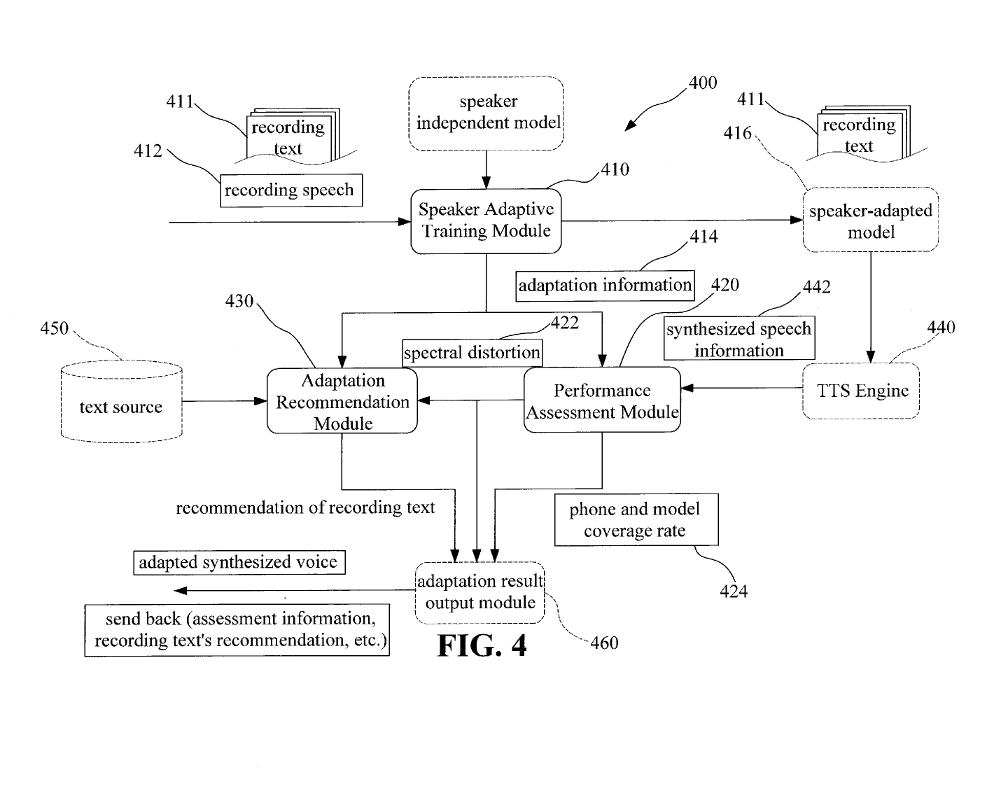

Accordingly, FIG. 4 shows a guided speaker adaptive speech synthesis system, according to an exemplary embodiment. Refer to FIG. 4, a speech synthesis system 400 comprises a speaker adaptive training module 410, a text-to-speech (TTS) engine 440, a performance assessment module 420, and an adaptation recommendation module 430. The speaker adaptive training module 410 adapts a speaker adaptive model 416 according to a recording text 411 and at least one recording speech 412. The speaker adaptive training module 410 performs an analysis according to the recording text 411, collects corresponding phone information and model information of the recording text 411. An adaptation information 414 produced by the speaker adaptive training module 410 includes at least the inputted recording speech 412, phonetic information generated by analyzing the recording speech 412, corresponding phone and a variety of model information of the recording text 411. The variety of model information used may be such as spectrum model information and prosody model information. The prosody model is the pitch model, since spectrum determines timbre and pitch has a key influence on the speech prosody.

A text-to-speech (TTS) engine 440 outputs synthesized speech information 442 according to the recording text 411 and the speaker adapted model 416. The synthesized speech information 442 includes at least the synthesis speech and the voiced segment information of the synthesized speech.

The performance assessment module 420 combines with the adaptation information 414 and the synthesized speech information 442 to estimate the assessment information of a current adapted speech. The assessment information comprises such as phone and model coverage rate 424, and one or more speech distortion assessment parameters (for example, spectral distortion 422, etc.). The phone and model coverage rate 424 includes, such as phone coverage rate, spectrum model coverage rate, pitch model coverage rate. Once statistical information of phone and model is obtained, the phone and model coverage rate may be calculated by applying the phone coverage formula and the model coverage formula. The estimation of the one or more speech distortion assessment parameters (such as spectral distortion and/or pitch distortion, etc.) may be obtained by using the inputted recording speech of the speaker adaptive training module 410 and the speech segment information of the recording speech and the synthesized speech provided by the TTS engine 440, and through a plurality of performing procedures. The detailed about how to estimate phone and model coverage rate and speech distortion assessment parameters will be described as follows.

The adaptation recommendation module 430 selects at least one subsequent recording text from a text source (for example, a text database) 450, as the recommendation of the next adaptation, according to the adaptation information 414 outputted from the speaker adaptation training module 410 and the assessment information of a current recording speech, such as spectral distortion, estimated by performance assessment module 420. The strategy of selecting the recording text by the adaptation recommendation module 430, may be such as, maximizing the phone/model coverage rate. The speech synthesis system 400 may output the assessment information of the current adapted speech estimated by the performance assessment module 420, such as the phone and model coverage rate, spectral distortion, etc., and the recommendation for the next adaptive speech made by the adaptation recommendation module 430, such as the recommendation of recording text, to an adaptation result output module 460. The adaptation result output module 460 may send back this information, such as the assessment information, recording text's recommendation, to the user or the client, or to a text and speech input processing module. Thus, the efficient speaker adaptation may be performed through constant adaptation and providing text recommendation, which makes the speech synthesis system 400 able to output the adapted synthesized voice with better quality and higher similarity via the adaptation results output module 460.

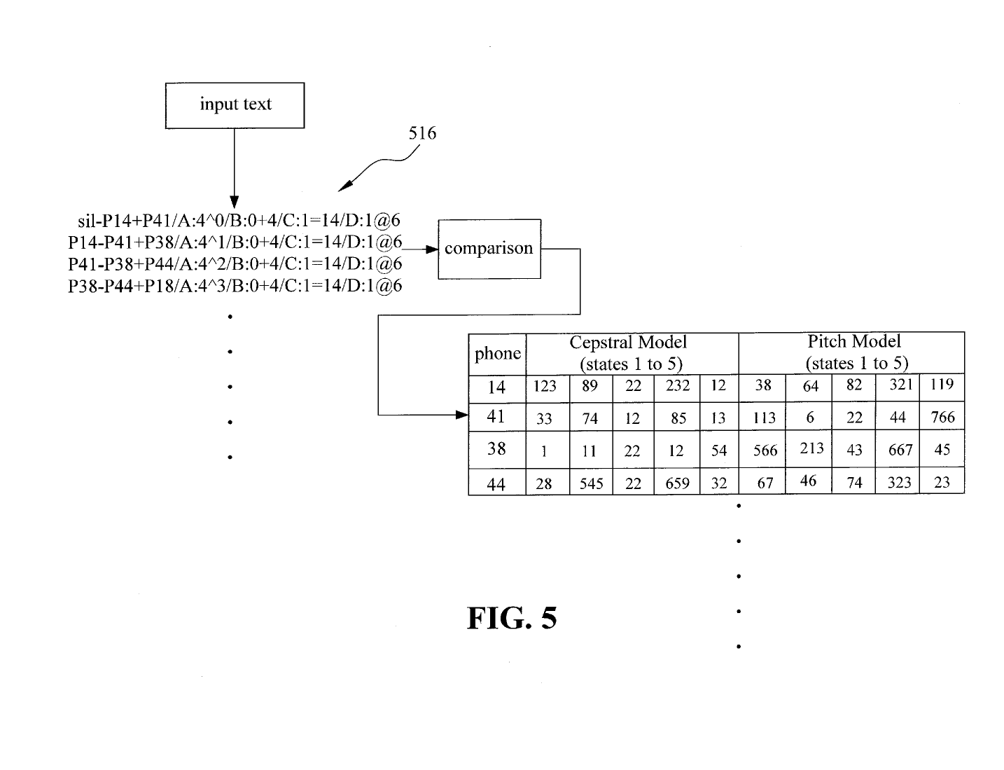

FIG. 5 shows an example illustrating the speaker adaptive training module which collects the corresponding phone and the model information for each of full label information from an input text, according to an exemplary embodiment. In the example of FIG. 5, the speaker adaptive training module converts the input text into multiple pieces of full label information 516, compares the multiple pieces of full label information 516 and collects corresponding phone information of each of the multiple pieces of full label information, the cepstral model numbers of states 1 to 5, and pitch model numbers of states 1-5. The more the model types are collected (higher coverage), the better the speech-adapted model may be obtained.

It may be seen from the FIG. 5, when a piece of full label information is inputted to a speech synthesis system, the cepstral model numbers and the pitch model numbers may be obtained by using such as a decision tree. The phone information of the piece of full label information may also be seen from the full label information itself Take the full label information, i.e. sil-P14+P41/A:4̂0/B:0+4/C:1=14/D:1@6, as an example, the phone is P14 (corresponding to a phonetic alphabet), while the left phone is sil (represents silence), and the right phone is P41 (corresponding to another phonetic alphabet). Thus collecting phone and model information of adapted speech data is quite intuitive, and this information-gathering process is executed in the adaptive training module. Once the statistical information of phones and models is obtained, one may apply the formula for the phone coverage rate and formula for the model coverage rate to estimate the phone and model coverage rate.

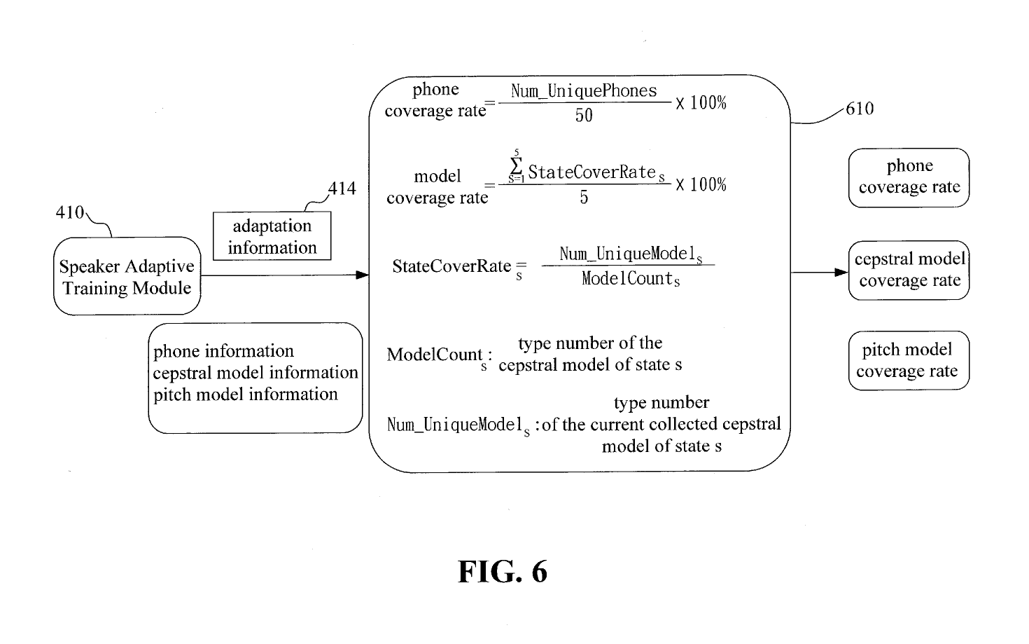

FIG. 6 shows an exemplar for estimating the phone coverage rate and the model coverage rate, according to an exemplary embodiment. In the coverage rate calculation formula 610 of FIG. 6, the value of the denominator (50 in this case) in the formula for estimating phone coverage rate represents 50 different phones in the TTS engine; and assuming that each of the cepstral model and the pitch model has five different states in the formulas for estimating model coverage. When the model is the cepstral model, the denominator of StateCoverRateₛ (i.e., variable ModelCountₛ) represents the overall type number of the cepstral model of the state s, and the nominator (i.e., variable Num_UniqueModelₛ) represents the type number of the current collected cepstral model of the state s. According to the formula for estimating the model coverage rate, one may estimate the cepstral model coverage rate. Similarly, when the model is the pitch model, one may estimate the pitch model coverage rate from the formula for estimating the model coverage rate.

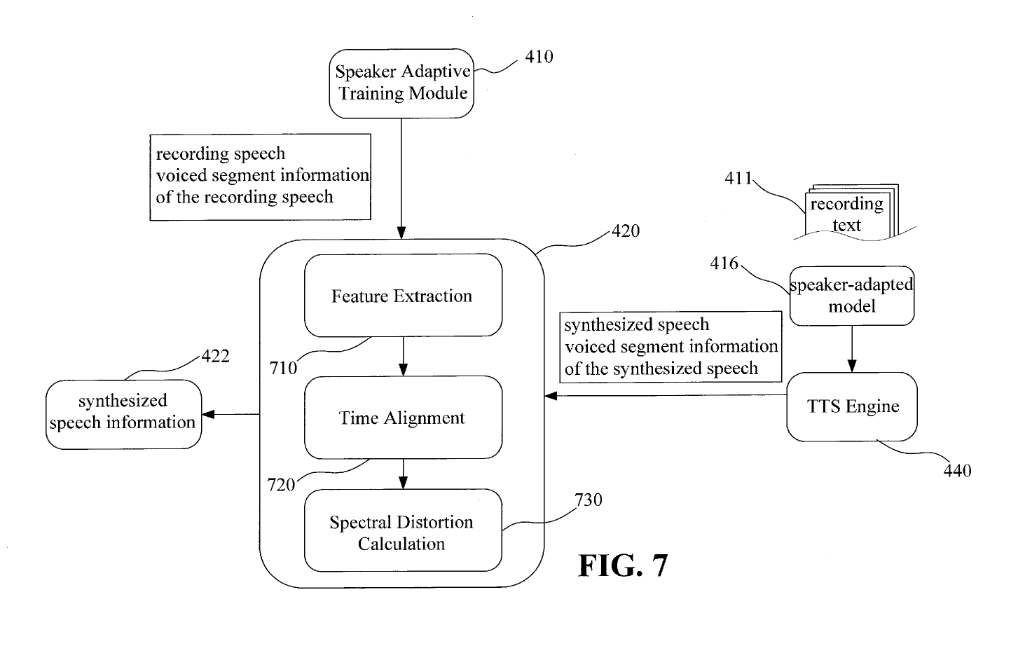

When the speech distortion assessment parameters estimated by the performance assessment module 420 contains the spectral distortion, it is more complex compared with the coverage rate calculation. FIG. 7 shows the operation for estimating the spectral distortion by the performance assessment module, according to an exemplary embodiment. As shown in FIG. 7, the spectral distortion estimation may be obtained by using the recording speech outputted from the speaker adaptive training module 410, the voiced segment information of the recording speech, and the synthesized speech and its voiced segment information provided by the TTS engine 440, and by further performing a feature extraction 710, a time alignment 720, and a spectral distortion calculation 730.

The feature extraction is firstly calculating the parameters of the speech, such as using the Mel-Cepstral parameter, or the linear prediction coding (LPC), or the line spectrum frequency (LSF), or the perceptual linear prediction (PLP) etc., as the reference speech features, then performing the time alignment comparing of the recording speech and the synthesized speech. Although voiced segment information of the recording speech and the synthesized speech are both known, the pronunciation duration of each word of the two kinds of speech is not identical. Thus time alignment is needed before calculating the spectral distortion. The Dynamic Time Warping (DTW) technique may be used for time alignment. Finally such as the Mel-Cepstral distortion (MCD) is taken as basis for calculating the spectral distortion indicator. The calculation formula of the MCD is as follows:

$${MCD}_{frame} = \frac{10}{ln 10} \sqrt{2 {\sum }_{i = 1}^{N} {( {mcp}_{i}^{( syn )} - {mcp}_{i}^{( tar )} )}^{2}} ,$$

wherein mcp is the Mel-Cepstral parameter, syn comes from the synthesized frame of the adapted speech, tar comes from the target frame of the real speech, and N is the mcp dimension. The spectral distortion of each speech unit (such as phone) may be estimated as follows:

$$Distortion = \frac{{\sum }_{f = 1}^{K} {MCD}_{f}}{K} ,$$

K is the number of the frames.
When the MCD value becomes higher, it represents that the similarity of the synthesis result is lower. Therefore, the current adaptation result of the system may be represented by this indicator.

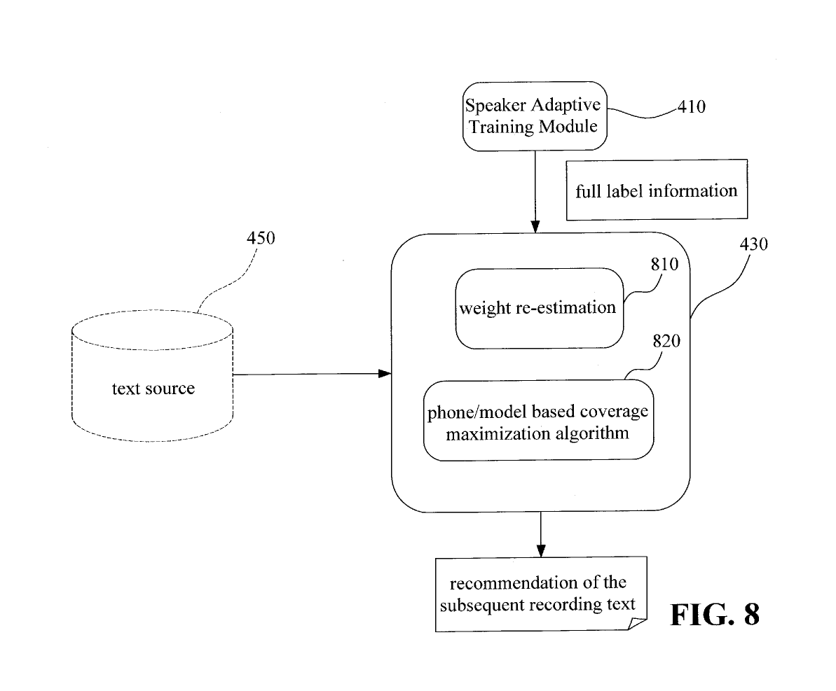

The adaptation recommendation module 430 combines the adaptation information 414 from the adaptive training module 410, and the assessment information estimated from the performance assessment module 420 such as the spectral distortion, to select a recommendation of at least one subsequent recording text from a text source. FIG. 8 illustrates a schematic diagram for the operation of the adaptation recommendation module, according to an exemplary embodiment. FIG. 8 shows the operation of the adaptation recommendation module, according to an exemplary embodiment. As shown in FIG. 8, the adaptation recommendation module 430 further utilizes a phone/model based coverage maximization algorithm 820, such as the greedy algorithm, to select the most suitable recording text, and in the process of executing this algorithm, refers to the result of a weight re-estimation 810; and then outputs the recommendation of the subsequent recording text.

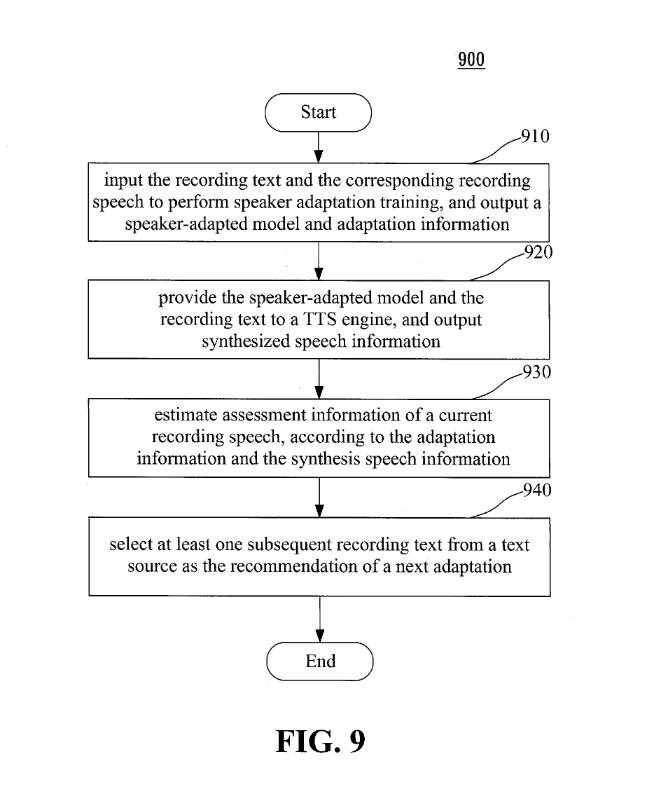

According to the above description on the guided speaker adaptive speech synthesis system and each component thereof, FIG. 9 shows a guided speaker adaptive speech synthesis method, according to an exemplary embodiment. As shown in FIG. 9, this speech synthesis method 900 firstly inputs the recording text and the corresponding recording speech to perform speaker adaptation training, and outputs a speaker-adapted model and adaptation information (step 910). Then it provides the speaker-adapted model and the recording text to a TTS engine, and outputs synthesized speech information (step 920). This speech synthesis method 900 further estimates assessment information of a current recording speech, according to the adaptation information and the synthesis speech information (step 930). Finally according to the adaptation information and the assessment information, the speech synthesis method 900 selects at least one subsequent recording text from a text source as the recommendation of a next adaptation (step 940).

Accordingly, the guided speaker adaptive speech synthesis method may comprise: inputting at least one recording text and at least one recording speech, and outputting an adaptation information and a speaker adaptive model; loading the speaker adaptive model and a given recording text, and outputting a synthesized speech information; inputting the adaptation information and the synthesized speech information, and estimating an assessment information; and selecting one or more subsequent recording texts from at least one text source as a recommendation of a next adaption process, according to the adaptation information and the assessment information.

The adaptation information includes at least the recording speech, and voiced segment information of the recording speech and the corresponding phone and model information of the recording speech. The synthesized speech information includes at least the synthesized speech and its voiced segment information. The assessment information includes at least phone and model coverage rate, and one or more speech distortion assessment parameters (such as the spectral distortion).

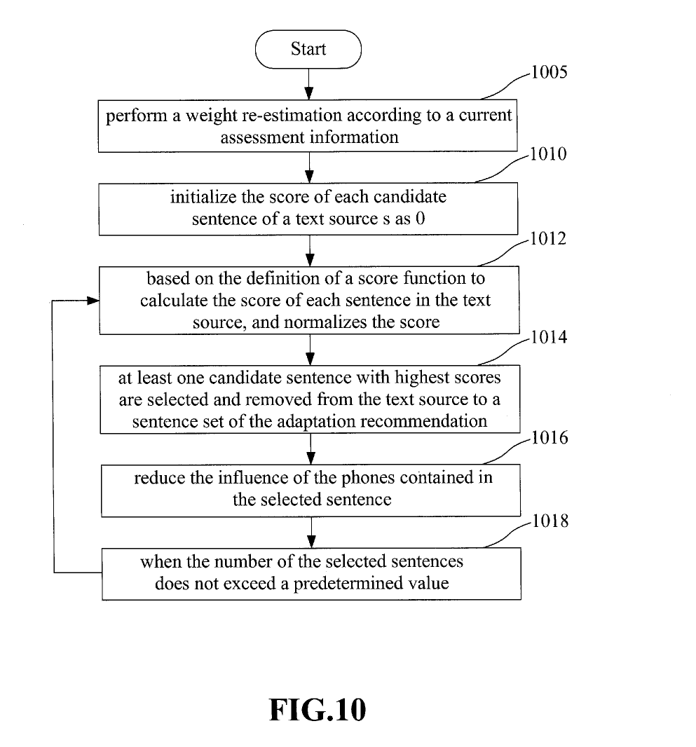

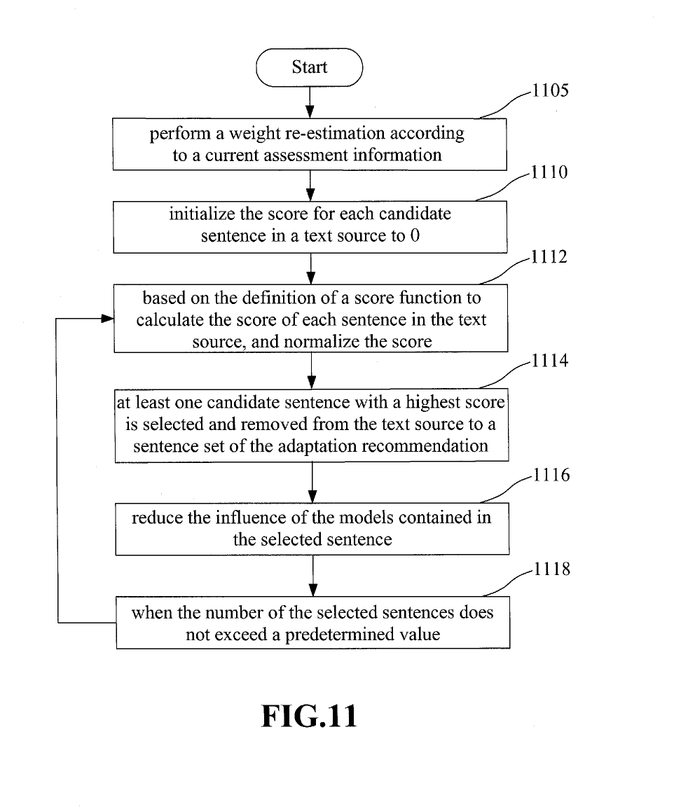

In the speech synthesis method 900, related contents on how to collect the corresponding phone and model information from the recording speech of an input text, and how to estimate the phone coverage rate and the model coverage rate, how to estimate the spectral distortion and the strategy of selecting the recording text have been described in the foregoing exemplary embodiments, and is not restated here. As stated before, the exemplary embodiments of the present disclosure firstly performs a weight re-estimation; then uses the phone and model based coverage maximization algorithms to select the recording text. FIG. 10 and FIG. 11 illustrate flow charts for a phone based coverage maximization algorithm and a model based convergence maximization algorithm, respectively, according to exemplary embodiments.

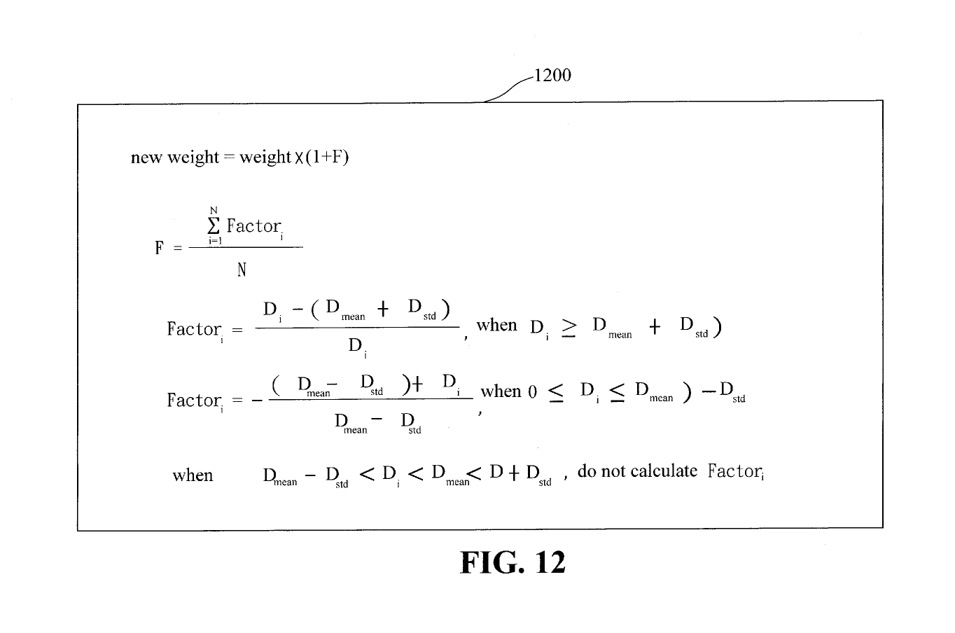

Refers to the flow chart in FIG. 10, firstly the phone based coverage maximization algorithm performs a weight re-estimation according to a current assessment information (step 1005). A new weight (PhoneID) of a phone and an updated influence (PhoneID) of the phone are obtained after the weight re-estimation is performed, wherein PhoneID is an identifier of the phone. The details of this weight re-estimation will be described in FIG. 12. Then, the score of each candidate sentence of a text source is initialized as 0 (step 1010); the algorithm is based on the definition of a score function to calculate the score of each sentence in the text source, and normalizes the score (step 1012); such as according to the number of phones in the sentence to perform this normalization (e.g., divide the total score by the number of phones). An exemplar for defining the score function of a phone is as follows:

Score=Weigtht(PhoneID)×10^{Influence(PhoneID)}

In the score function mentioned above, the score of a phone is determined by the weight and the influence of the phone. The weight(PhoneID) value is the reciprocal of the number of occurrences for PhoneID in a large text corpus. In other words, the higher the number of occurrences is, the lower the weight(PhoneID) value is. The impact(PhoneID) value is initialized to some natural number, e.g. 20, and will be decreased by one (till zero) whenever PhoneID is picked up during the selection process. Such design can reflect their lessening importance in the next iteration.

The more the phone categories, the higher the candidate sentence's score. Finally at least one candidate sentence with highest score is selected and removed from the text source to a sentence set of the adaptation recommendation (step 1014), and the influence of the phones contained in the selected sentence is reduced (step 1016), in order to facilitate the next selecting opportunity of other phones. When the number of the selected sentences does not exceed a predetermined value (step 1018), then step 1012 is performed, and the scores of all remaining candidate sentences in the text source are re-calculated. And the above process is repeated until the number of selected sentences exceeds the predetermined value.

Refers to the flowchart in FIG. 11, first of all, this model based coverage maximization algorithm performs a weight re-estimation according to a current assessment information (step 1105). After the weight re-estimation is performed, a new MCP weight and a new LF0 weight of these two models, and two update influences Influence(Mₛ^{L}) and Influence(Pₛ^{L}) of these two models may be obtained, wherein Mₛ^{L} indicates a corresponding spectral (MCP) model when the state is s and the text label information is L. Similarly, Pₛ^{L} indicates a corresponding pitch (LF0) model when the state is s and the text label information is L. The text label information is defined as the full label information obtained after the inputted recording text and through a text analysis of the speaker adaptive training module, as shown in 516 of FIG. 5. The details of the weight re-estimation will be described in the FIG. 12. Then, the exemplary embodiment initializes the score for each candidate sentence in a text source to 0 (step 1110). This algorithm is based on the definition of a score function to calculate the score of each sentence in the text source, and normalizes the score (step 1112), such as by performing the normalization (e.g., divide the total score by the number of phones) based on the number L (text label) in the sentence. An exemplary embodiment for defining score function of a model is as follows:

$$Score = {\sum }_{s = 1}^{5} ( MCP Score ( {M}_{s}^{L} ) + LF 0 Score ( {P}_{s}^{L} ) )$$

$$MCPScore ( {M}_{s}^{L} ) = Weight ( {M}_{s}^{L} ) \times {10}^{Influence ( {M}_{s}^{L} )}$$

$$LF 0 Score ( {P}_{s}^{L} ) = Weight ( {P}_{s}^{L} ) \times {10}^{Influence ( {P}_{s}^{L} )} .$$

In the score function mentioned above, the score is determined according to a cepstral model score and a pitch model score. A cepstral model score or a pitch model score is determined by the weight and the influence of the model. In the model score function mentioned above, the system initializes the cepstral model's weight Weight(Mₛ^{L}) and the pitch model's weight Weight(Pₛ^{L}), by taking the reciprocal of the number of occurrences as the MCP models and the LF0 models. Therefore, the more frequently the model appears in the storage medium e.g. the data corpus, the lower its model weight is. The values of Influence(Mₛ^{L}) and Influence(Pₛ^{L}) are initialized to a natural number, for example, five. The value is decreased by one whenever Mₛ^{L} is picked up during the selection process. Such design can reflect their lessening importance in the next iteration.

The candidate sentence with more MCP and LF0 models types may obtain a higher score. Finally, at least one candidate sentence with a highest score is selected and removed from the text source to a sentence set of the adaptation recommendation (step 1114), and the influence of the models contained in the selected sentence is reduced (step 1116), in order to facilitate the next selecting opportunity of other models. When the number of the selected sentences does not exceed a predetermined value (step 1118), then step 1112 is performed. And, the scores of all remaining candidate sentences in the text source are re-calculated, and the above process is repeated until the number of selected sentences exceeds the predetermined value.

In other words, model based coverage maximization algorithm defines a score function of a model to perform the score estimation for each candidate sentence in a text source. The more model types a candidate sentence has, the higher its score will be. Finally, at least one candidate sentence with the highest score is selected and removed from the text source into a sentence set of the adaptation recommendation, and the influence of the models contained in the selected sentence is reduced in order to facilitate the next selecting opportunity of other models. Then the scores of all remaining candidate sentences in the text source are re-calculated, and the above process is repeated until the number of selected sentences exceeds the predetermined value.

According to the aforementioned in the flow charts of FIG. 10 and FIG. 11, in the phone based coverage maximization algorithm or the model based coverage maximization algorithm, the weight re-estimation plays a key role. It determines, based on the spectral distortion, the new phone weight and the new model weight such as new Weight(PhoneID), Weight (Mₛ^{L}) and Weight(Pₛ^{L}), and uses a timbre similarity method to dynamically adjust the level of the weight. The weight re-estimation uses the timbre similarity method to dynamically adjust the level of the weight, so that the reference for selecting at least one subsequent text not only takes the coverage (based only on the text reference) into account but also considers the feedback of the synthesis result. The timbre similarity usually based on the spectral distortion to estimate. If the spectral distortion of a speech unit (such as phone or syllable or word) is too high, it indicates that the adaptation result is not good enough and the subsequent text should strengthen the selection of this unit, therefore its weight should be increased. On the contrary, when the spectral distortion of a speech unit is very low, it indicates that the adaptation result has been good enough, and the weight of the subsequent text should be lowered, so that the selecting opportunities of other speech units may be increased. Thus, in the disclosed exemplary embodiments, the weight adjustment principle is, when the spectral distortion of a speech unit is higher than a high threshold value (e.g., the mean distortion of the original speech plus the standard deviation of the original speech), increases the weight of the speech unit; when the spectral distortion of a speech unit is lower than a low threshold value (e.g., the mean distortion of the original speech minus the standard deviation of original speech), decreases the weight of the speech unit.

FIG. 12 shows an adjustment scheme of the weight re-estimation, according to an exemplary embodiment. In the formula 1200 of the adjustment scheme of the weight re-estimation shown in FIG. 12, Di represents the i-th distortion of a speech unit (e.g., phone unit), Dₘₑₐₙ represents the mean distortion of the adaptation data, D_{std} represents the standard deviation of the adaptation data. N represents the number of units involved in this weight adjustment (for example, five involved in the calculation of phone P14). Each factor, Factorᵢ, estimated by the same speech unit is not identical, therefore the mean of these factors (i.e., the mean factor F) is taken as the representative. Finally, adjusting the new weight is performed according to the mean factor F. One exemplary adjustment formula is new weight=weight×(1+F), wherein the value of the mean factor F may be a positive value or a negative value.

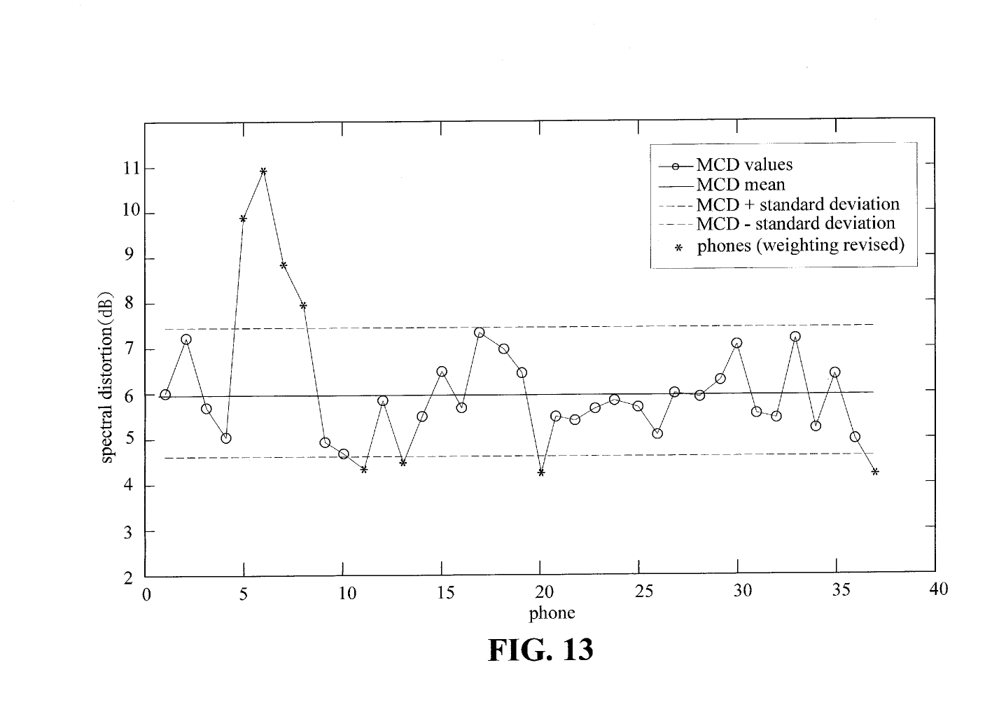

FIG. 13 illustrates a schematic view illustrating the spectral distortion between the synthesized speech and the original for a sentence of which the spectral distortion calculation unit is a phoneme, according to an exemplary embodiment, wherein the horizontal axis represents different phones, the vertical axis represents the spectral distortion (the unit of the vertical axis is dB), and the speech unit for calculating the spectral distortion is phone. Since the spectral distortions of phones 5 to 8 are higher than (Dₘₑₐₙ+D_{std}), therefore, according to the weight adjustment principle of the disclosed exemplary embodiments, weights of phone 5, phone 6, phone 7 and phone 8 are increased; while the spectral distortions of phone 11, phone 13, phone 20 and phone 37 are lower than (Dₘₑₐₙ−D_{std}), therefore, according to the weight adjustment principle of the disclosed exemplary embodiments, weights of phone 11, phone 13, phone 20, and phone 37 are decreased.

In the above exemplary embodiment of the guided speaker adaptive speech synthesis method may be implemented by a computer program product. The computer program products may use at least one hardware processor to read program codes embedded in a storage media to execute this method. Yet in accordance with one exemplary embodiment of the disclosure, the computer program product may comprise a storage media having a plurality of readable program codes, and use the at least one hardware processor reading the readable program code embedded in the storage media to execute: inputting at least one recording text and at least one recording speech, and outputting an adaptation information and a speaker adaptive model; loading the speaker adaptive model and a given recording text, and outputting a synthesized speech information; inputting the adaptation information and the synthesized speech information, and estimating an assessment information; and selecting one or more subsequent recording texts from at least one text source as a recommendation of a next adaption process, according to the adaptation information and the assessment information.

In summary, the disclosed exemplary embodiments provide a guided speaker adaptive speech synthesis system and method. Its technology inputs at least one recording text and at least one recording speech, and outputs adaptation information and a speaker adaptive model; a TTS engine reads the speaker adaptive model and the recording text, and outputs synthesized speech information; then combines with the adaptation information and the synthesized speech information, and estimates assessment information, and selects at least one subsequent recording text according to the adaptation information and the assessment information as a recommendation for a next adaptation. This technique considers phone and model coverage rate, selects speech with the distortion as the criteria, and makes a recommendation for a next speech adaption, thereby guiding users/clients reinforcing input the speech data corpus for the deficiencies of a previous adaptation process, to provide good voice quality and similarity.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A guided speaker adaptive speech synthesis system, comprising:
a speaker adaptive training module that outputs an adaptation information and a speaker-adapted model, according to a recording text inputted and at least one corresponding recording speech;
a text to speech engine that receives the recording text inputted and the speaker-adapted model, and outputs a synthesized speech information;
a performance assessment module that refers to the adaptation information and the synthesized speech information to generate an assessment information; and
an adaptation recommendation module that selects at least one subsequent recording text from at least one text source as a recommendation of a next adaption process, according to the adaptation information and the assessment information.

2. The system as claimed in claim 1, wherein said adaptation information outputted by said adaptive training module at least includes said recording text, said recording speech, information of at least one phone and at least one model corresponding to the recording text, and a corresponding voiced segment information of the recording speech.

3. The system as claimed in claim 2, wherein the information at least includes a spectral model information and a pitch model information.

4. The system as claimed in claim 1, wherein said synthesized speech information outputted by said text to speech engine at least includes one synthesized speech of said recording text, and a voiced segment information of said synthesized speech.

5. The system as claimed in claim 1, wherein said assessment information at least includes a phone coverage rate and a model coverage rate of said recording text.

6. The system as claimed in claim 5, wherein said phone and model coverage rate includes a phone coverage rate, a spectral model coverage rate, and a pitch model coverage rate.

7. The system as claimed in claim 1, wherein said assessment information at least includes one or more speech distortion assessment parameters.

8. The system as claimed in claim 7, wherein said one or more speech distortion assessment parameters at least include a spectral distortion of said recording speech and said synthesized speech.

9. The system as claimed in claim 1, wherein a strategy of said adaptation recommendation module selecting the recording text is to maximize said phone and said model coverage rates.

10. The system as claimed in claim 1, wherein said system is a hidden Markov model-based or hidden semi Markov model-based speech synthesis system.

11. The system as claimed in claim 1, wherein said system performs a speaker adaptation by at least one constant adaptation and providing at least one text recommendation.

12. The system as claimed in claim 1, wherein said system outputs said synthesized speech, said assessment information of a current recording speech estimated by said performance assessment module, and the recommendation of said next adaption made by said adaptation recommendation module.

13. A guided speaker adaptive speech synthesis method, comprising:
inputting at least one recording text and at least one recording speech, and outputting an adaptation information and a speaker adaptive model;
loading the speaker adaptive model and inputting a recording text, and outputting a synthesized speech information;
inputting the adaptation information and the synthesized speech information, and estimating an assessment information; and
selecting at least one subsequent recording text from at least one text source as a recommendation of a next adaption process, according to the adaptation information and the assessment information.

14. The method as claimed in claim 13, wherein said assessment information includes a phone coverage rate, a cepstral model coverage rate and a pitch model coverage rate of said current recording speech, and one or more speech distortion assessment parameters.

15. The method as claimed in claim 13, wherein said one or more speech distortion assessment parameters at least includes a spectral distortion.

16. The method as claimed in claim 13, wherein said method performs a weight re-estimation at the beginning, and then uses a phone-based coverage maximization algorithm and a model-based coverage maximization algorithm to select said at least one subsequent recording text.

17. The method as claimed in claim 16, wherein said weight re-estimation determines a new phone weight and a new model weight based on a spectral distortion, and uses a timbre similarity method to dynamically adjust the new phone weight and the new model weight.

18. The method as claimed in claim 17, wherein a principle of adjusting a weight of the new phone weight and the new model weight is when the spectral distortion of a speech unit is higher than a high threshold, increasing the weight of said speech unit; when the spectral distortion of the speech unit is lower than a low threshold, decreasing the weight of the speech unit.

19. The method as claimed in claim 18, wherein said speech unit is one or more combinations of a word, a syllable, and a phone.

20. The method as claimed in claim 16, wherein said phone-based coverage maximization algorithm defines a score function of a phone to perform a score estimation for each candidate sentence in a text source, wherein a candidate sentence with more phone types obtains a higher score, and selects at least one candidate sentence with a highest score from said text source and moves the at least one candidate sentence with the highest score to a sentence set of the adaptation recommendation, and an influence of phones contained in said selected sentence is reduced to facilitate an increasing selecting opportunity of other phones, then re-calculates scores of all candidate sentences in said text source, and repeats the above process until the number of selected sentences exceeds a predetermined value.

21. The method as claimed in claim 20, wherein according to the definition of said score function, a phone score is decided based on the weight and the influence of said phone.

22. The method as claimed in claim 16, wherein said model-based coverage maximization algorithm defines a score function of a model to perform a score estimation for each candidate sentence in a text source, wherein a candidate sentence with more model types obtains a higher score, and selects at least one candidate sentence with a highest score from said text source and moves the at least one candidate sentence with the highest score to a sentence set of the adaptation recommendation, and an influence of models contained in said selected sentence is reduced to facilitate an increasing selecting opportunity of other models, then recalculates scores of all candidate sentences in said text source, and repeats the above process until the number of selected sentences exceeds a predetermined value.

23. The method as claimed in claim 22, wherein according to the definition of said score function, a model score is decided based on a cepstral model score and a pitch model score, and the cepstral or pitch model score depends on the weight and the influence of said cepstral or pitch model.

24. A computer program product of a guided speaker adaptive speech synthesis method, comprising a storage medium having a plurality of readable program codes, and using at least one hardware processor to read the plurality of readable program codes to execute:
inputting at least one recording text and at least one recording speech, and outputting an adaptation information and a speaker adaptive model;
loading the speaker adaptive model and inputting a recording text, and outputting a synthesized speech information;
inputting the adaptation information and the synthesized speech information, and
estimating an assessment information; and
selecting one or more subsequent recording texts from at least one text source as a recommendation of a next adaption process, according to the adaptation information and the assessment information.

25. The computer program product as claimed in claim 24, wherein said assessment information includes a phone coverage rate, a cepstral model coverage rate and a pitch model coverage of said current recording speech, and one or more speech distortion assessment parameters.

26. The computer program product as claimed in claim 24, said one or more speech distortion assessment parameters at least includes a spectral distortion.

27. The computer program product as claimed in claim 24, said computer program product performs a weight re-estimation, and uses a phone-based coverage maximization algorithm and a model-based coverage maximization algorithm to select said at least one subsequent recording text.

28. The computer program product as claimed in claim 27, wherein said weight re-estimation determines a new phone weight and a new model weight based on a spectral distortion, and uses a timbre similarity method to dynamically adjust the new phone weight and the new model weight.

29. The computer program product as claimed in claim 28, wherein a principle of adjusting a weight of the new phone weight and the new model weight is when the spectral distortion of a speech unit is higher than a high threshold, increasing the weight of said speech unit; when the spectral distortion of the speech unit is lower than a low threshold, decreasing the weight of the speech unit.

30. The computer program product as claimed in claim 29, wherein said speech unit is one or more combinations of a word, a syllable, and a phone.

31. The computer program product as claimed in claim 27, wherein said phone-based coverage maximization algorithm defines a score function of a phone to perform a score estimation for each candidate sentence in a text source, wherein a candidate sentence with more phone types obtains a higher score, and selects at least one candidate sentence with a highest score from said text source and moves the at least one candidate sentence with the highest score to a sentence set of the adaptation recommendation, and an influence of phones contained in said selected sentence is reduced to facilitate an increasing selecting opportunity of other phones, then re-calculates scores of all candidate sentences in said text source, and repeats the above process until the number of selected sentences exceeds a predetermined value.

32. The computer program product as claimed in claim 31, wherein according to the definition of said score function, a phone score is decided based on the weight and the influence of said phone.

33. The computer program product as claimed in claim 27, wherein said model-based coverage maximization algorithm defines a score function of a model to perform a score estimation for each candidate sentence in a text source, wherein a candidate sentence with more model types obtains a higher score, and selects at least one candidate sentence with a highest score from said text source and moves the at least one candidate sentence with the highest score to a sentence set of the adaptation recommendation, and an influence of models contained in said selected sentence is reduced to facilitate an increasing selecting opportunity of other models, then re-calculates scores of all candidate sentences in said text source, and repeats the above process until the number of selected sentences exceeds a predetermined value.

34. The method as claimed in claim 33, wherein according to the definition of said score function, a model score is decided based on a cepstral model score and a pitch model score, and the cepstral or pitch model score depends on the weight and the influence of said cepstral or pitch model.
